(19) United States
(12) Patent Application Publication
(10) Pub. No.: US 2005/0265550 A1
(43) Pub. Date: Dec. 1, 2005

(54) Polynomial-based multi-user key generation and authentication method and system

(75) Inventors: Pim Theo Tuyls, Eindhoven (NL); Thomas A.M. Kevenaar, Eindhoven (NL); Geert Jan Schrijen, Eindhoven (NL); Marten Erik Van Dijk, Cambridge, MA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/507,190

(22) PCT Filed: Feb. 14, 2003
(86) PCT No.: PCT/IB03/00655

§ 371 Date: Sep. 9, 2004

(30) Foreign Application Priority Data
Mar. 13, 2002 (EP) 02075983.3

(51) Int. Cl. H04L 9/00

(52) U.S. Cl. 380/259

(57) ABSTRACT

A method of generating a common secret between a first party and a second party, preferably devices (101-105) in a home network (100) that operate in accordance with a Digital Rights Management (DRM) framework. The devices calculate the common secret by evaluating the product of two polynomials P(x, y) and Q(x, z) using parameters previously distributed by a Trusted Third Party (TTP) and parameters obtained from the other party. Preferably the parties subsequently verify that the other party has generated the same secret using a zero-knowledge protocol or a commitment-based protocol. The method is particularly suitable for very low power devices such as Chip-In-Disc type devices.

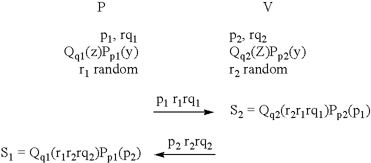

The invention relates to a method of generating a common secret between a first party and a second party, in which the first party holds a value p₁ and a symmetrical polynomial P(x,y) fixed in the first argument by the value p₁, and the first party performs the steps of sending the value p₁ to the second party, receiving a value p₂ from the second party and calculating the secret S₁ by evaluating the polynomial P(p₁, y) in p₂.

The invention further relates to a system comprising a first party, a second party and a trusted third party, arranged to execute such a method, to devices arranged to function as first or second party in this system and to a computer program product.

An embodiment of the method according to the preamble is known from R. Blom, Non-public key distribution, Advances in Cryptology-Proceedings of Crypto 82, 231-236, 1983.

Authentication plays an important role in digital communication networks and in content protection systems. Devices that communicate with each other need to be convinced of each other's trustworthiness. They should not give confidential information to a non-trusted party. Authentication procedures are often based on public key techniques which require a lot of processing power. In many applications this (processing) power is not available in which case these public key techniques can not be applied straightforwardly.

A solution that is sometimes proposed, is based on the use of symmetric ciphers which consume much less power. However these suffer from the drawback that they require a global system secret in each device which is not desirable for products that come in large numbers.

Digital communication networks are becoming more and more common also in CE applications and drive the need for cheap and low power authentication protocols. Although this power constraint is in general true for portable CE devices and smart-cards etc., it is especially tight in “Chip In Disc” (CID) type-products, such as described in international patent application WO 02/017316 (attorney docket PHNL010233) by the same applicant as the present application.

The basic approach behind CID is to put a chip on a carrier like a CD or DVD, which is then used for content protection purposes. The chip will allow the player to play the content (give it access to the descramble keys it carries) as soon as it is convinced that the player can be trusted. On the other hand, the player will not play any content on a non-trusted disc. Therefore both, the player and the CID need some means for authentication.

It is important to note that the chip has only very limited power (approximately 0.5 mW) at its disposal and can therefore not carry out very complicated calculations. This means that public key techniques (such as RSA or ElGamal) cannot be used immediately. The CID authentication problem is a typical example of an authentication problem in the CE world.

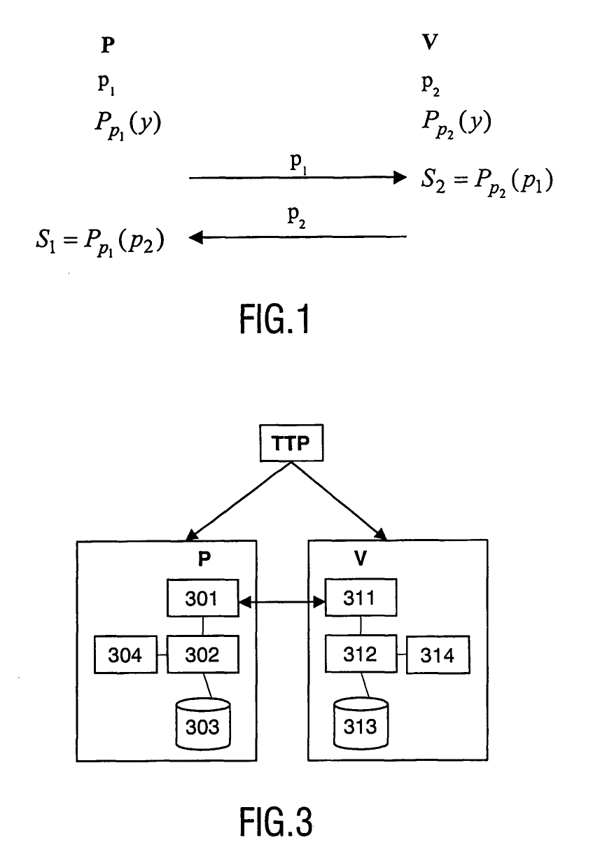

The article by Blom referenced above discloses a common key or conference key generation method using a secret sharing protocol based on a symmetric polynomial in two variables. This protocol is illustrated in FIG. 1. Basically, one party, called the prover (abbreviated as P) tries to convince another party in the system, called the verifier (abbreviated as V) that he knows a secret that is also known to the verifier. If the verifier is convinced, the prover is authenticated.

In the system, a Trusted Third Party (TTP) chooses a symmetric (n+1)×(n+1) matrix T, whose entries tᵢⱼ represent respective coefficients of an n-th degree polynomial P in two variables, which is defined as follows:

$$P ( x , y ) = {\sum }_{i , j = 0}^{n} {t}_{ij} {x}^{i} {y}^{j}$$

It is clear that P(x, y)=P(y, x) for all x and y in the domain of the polynomial. The polynomial P can be projected on the space of n-th degree polynomials in one variable by fixing the argument x to a certain value, say p: Pₚ(y)=P(p, y). From the definition of the polynomial P, the symmetry of the matrix T and the resulting symmetry of P(x, y) it then follows that Pₚ(q)=P_{q}(p) for all p and q.

According to Blom, every device that needs to be able to generate a common secret with an other device receives a pair (Pₚ(y), p), i.e. the polynomial P fixed in p and the value p which was used to generate Pₚ(y) from P(x, y). The shared secret between the devices (Pₚ, p) and (P_{q}, q) is given by Pₚ(q)=P_{q}(p) which is generated by exchanging p and q and evaluating the polynomials to yield a secret S₁ for P and S₂ for V.

In this approach the global secret consists of the matrix T which has ½(n+1)(n+2) independent entries because it is symmetric. A share of this secret is given to every party in the form of a respective value p and the polynomial Pₚ(y) with n+1 coefficients of the form

$${g}_{j} = {\sum }_{i = 0}^{n} {t}_{ij} {p}^{i}$$

This gives every party n+1 linear equations in the ½(n+1)(n+2) unknowns tᵢⱼ which makes it clear that one party can not retrieve the global secret T. Only if n+1 parties, all with a different value p cooperate will it be possible to retrieve the matrix T.

This presents a major drawback of the known protocol: if a sufficient number of parties cooperate, the global secret T can be retrieved, unless the number of different values of pᵢ is less than n+1. But this means that the number of different shares is limited to the degree of the polynomial to prevent revealing the global system secret T. Furthermore, when two parties communicate they always generate the same common secret.

It is an object of the invention to provide a method according to the preamble, which allows a greater number of different shares of the global secret to be distributed to parties without having to increase the order of the polynomial P.

This object is achieved according to the invention in a method which is characterized in that the first party additionally holds a value q₁ and a symmetrical polynomial Q(x, y) fixed in the first argument by the value q₁, and further performs the steps of sending q₁, to the second party, receiving a value q₂ from the second party and calculating the secret S₁ as S₁=Q(q₁, q₂)·P(p₁, p₂).

While the number of values for pᵢ is still limited to n, a larger number of different shares can now be distributed to the parties. The number of values for qᵢ in the total system is not limited by the degree of the polynomial P, as is the case in the Blom system, but only by the number of possible elements qᵢ in the domain of Q. This makes it possible for a sufficient number of qᵢ's to supply every party with a unique share of the global secret.

In an embodiment the first party further performs the steps of obtaining a random number r₁, calculating r₁·q₁, sending r₁·q₁ to the second party, receiving r₂·q₂ from the second party and calculating the secret S₁ as S₁=Q(q₁, r₁·r₂·q₂)·P(p₁, p₂). The random numbers r₁ and r₂ hide the values of q₁ and q₂, which makes it very difficult for an eavesdropper or a non-compliant device to learn something about q₁ and q₂. Secondly, the values of r₁ and r₂ end up multiplicatively in the results of the evaluation of the polynomials P and Q, and thus the calculated secrets S₁ and S₂ have a random character, too. This means that, if S₁ and S₂ are used as a key in a symmetric cipher later on, it will be difficult for an eavesdropper to break the encryption. Additionally, a different common secret can now be generated at every new session between two devices.

In a further embodiment the first party holds the value q₁ multiplied by an arbitrarily chosen value r, and the product Q(q₁, z)P(p₁, y) instead of the individual polynomials P(p₁, y) and Q(q₁, z), and the first party performs the steps of calculating r₁·r·q₁, sending r₁·r·q₁ to the second party, receiving r₂·r·q₂ from the second party and calculating the secret S₁ as S₁=Q(q₁, r₁·r₂·r·q₂)·P(p₁, p₂). This way, the values q₁ and q₂ are hidden to an adversary who gains access to a device and tries to learn the global secret T and/or the values q₁ or q₂.

In a further embodiment the first party and the second party use a non-linear function on the generated secret S1 and S2, respectively, before using it as a secret key in further communications. The non-linear function is preferably implemented as a one-way hash function but can also take the form of a polynomial. Using a non-linear function makes the scheme forward and backward secure. In other words, even if an attacker manages to obtain a key, he cannot derive previous or subsequent keys from this obtained key.

Preferably, the first party subsequently verifies that the second party knows the secret S₁. The first party could apply a zero-knowledge protocol to verify that the second party knows the secret S₁. Preferably this protocol is the Guillou-Quisquater protocol with public values e and m. This has the advantage that in the present invention the Guillou-Quisquater protocol can be very secure for low values of e because it does not allow an adversary to anticipate a challenge. Furthermore it is efficient in terms of communication and memory usage.

Alternatively, the first party can apply a commitment-based protocol to verify that the second party knows the secret S₁. Using a commitment protocol based on a symmetric cipher such as DES, Lombok or AES is very efficient in terms of power consumption in a device executing the method. Preferably, the first party subsequently uses the same symmetric cipher as a commit function to commit himself to a decryption of the encrypted random challenge. This has the additional advantage that the complexity of the implementation is now reduced, as the hardware and/or software for encrypting the challenge can be reused for executing the commit function.

Other advantageous embodiments are set out in the dependent claims.

These and other aspects of the invention will be apparent from and elucidated with reference to the embodiments shown in the drawings, in which:

FIG. 1 illustrates a secret sharing protocol based on a symmetric polynomial in two variables according to Blom;

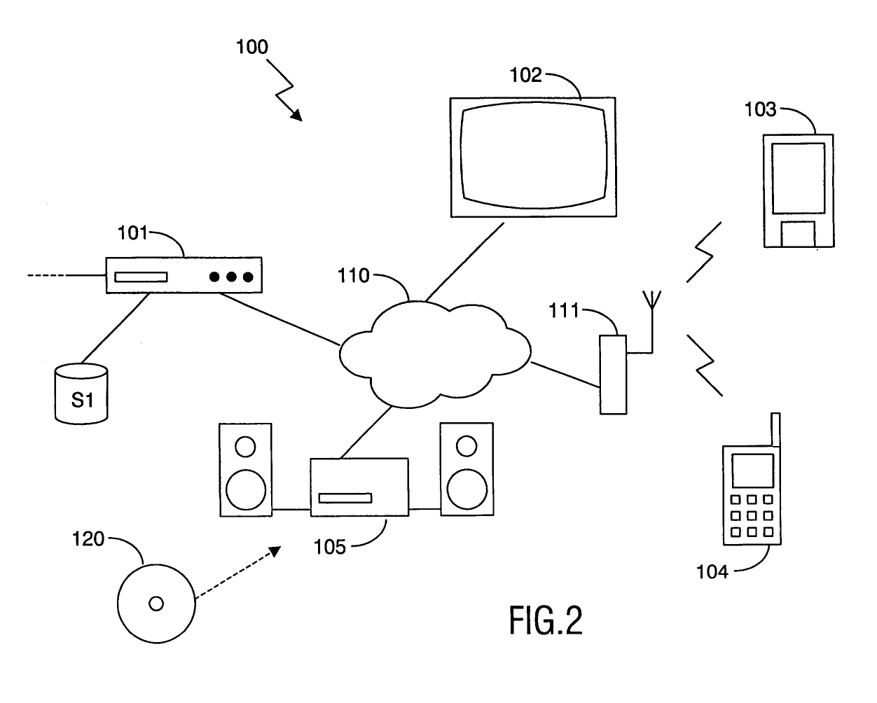

FIG. 2 schematically shows a system comprising devices interconnected via a network, the devices being arranged to operate in accordance with the invention;

FIG. 3 schematically shows a generalization of the system of FIG. 2, comprising a prover, a verifier and a trusted third party;

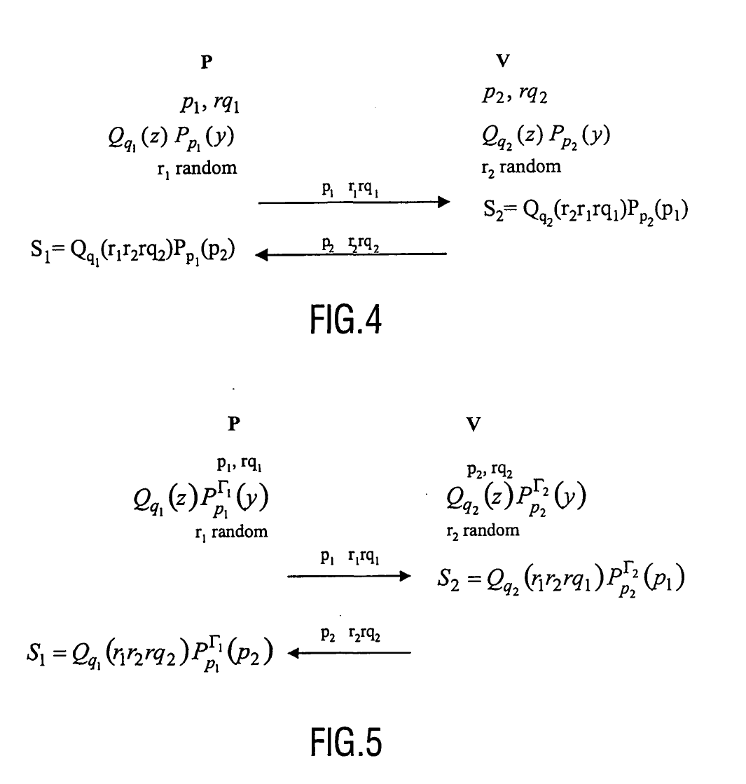

FIG. 4 illustrates a secret sharing protocol between the prover and the verifier, based on two symmetrical polynomials each in two variables;

FIG. 5 illustrates a variation on the protocol of FIG. 4 in which the two polynomials are symmetrical only in a limited number of points;

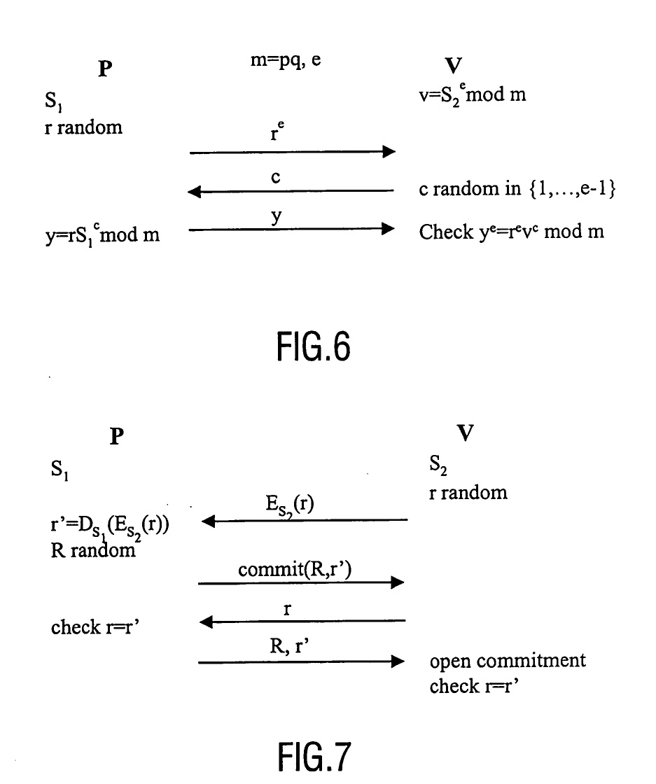

FIG. 6 illustrates the Guillou-Quisquater protocol; and

FIG. 7 illustrates a commitment-based protocol.

Throughout the figures, same reference numerals indicate similar or corresponding features. Some of the features indicated in the drawings are typically implemented in software, and as such represent software entities, such as software modules or objects.

FIG. 2 schematically shows a system 100 comprising devices 101-105 interconnected via a network 110. In this embodiment, the system 100 is an in-home network. A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set top box (STB), is usually the central device, providing central control over the others.

Content, which typically comprises things like music, songs, movies, TV programs, pictures and the likes, is received through a residential gateway or set top box 101. The source could be a connection to a broadband cable network, an Internet connection, a satellite downlink and so on. The content can then be transferred over the network 110 to a sink for rendering. A sink can be, for instance, the television display 102, the portable display device 103, the mobile phone 104 and/or the audio playback device 105.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 101, or any other device in the system 100, may comprise a storage medium S1 such as a suitably large hard disk, allowing the recording and later playback of received content. The storage S1 could be a Personal Digital Recorder (PDR) of some kind, for example a DVD+RW recorder, to which the set top box 101 is connected. Content can also be provided to the system 100 stored on a carrier 120 such as a Compact Disc (CD) or Digital Versatile Disc (DVD).

The portable display device 103 and the mobile phone 104 are connected wirelessly to the network 110 using a base station 111, for example using Bluetooth or IEEE 802.11b. The other devices are connected using a conventional wired connection. To allow the devices 101-105 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

It is often important to ensure that the devices 101-105 in the home network do not make unauthorized copies of the content. To do this, a security framework, typically referred to as a Digital Rights Management (DRM) system is necessary.

In one such framework, the home network is divided conceptually in a conditional access (CA) domain and a copy protection (CP) domain. Typically, the sink is located in the CP domain. This ensures that when content is provided to the sink, no unauthorized copies of the content can be made because of the copy protection scheme in place in the CP domain. Devices in the CP domain may comprise a storage medium to make temporary copies, but such copies may not be exported from the CP domain. This framework is described in International patent application PCT/IB02/04803 (attorney docket PHNL010880) by the same applicant as the present application.

Regardless of the specific approach chosen, all devices in the in-home network that implement the security framework do so in accordance with the implementation requirements. Using this framework, these devices can authenticate each other and distribute content securely. Access to the content is managed by the security system. This prevents the unprotected content from leaking to unauthorized devices and data originating from untrusted devices from entering the system.

It is important that devices only distribute content to other devices which they have successfully authenticated beforehand. This ensures that an adversary cannot make unauthorized copies using a malicious device. A device will only be able to successfully authenticate itself if it was built by an authorized manufacturer, for example because only authorized manufacturers know a particular secret necessary for successful authentication or their devices are provided with a certificate issued by a Trusted Third Party.

Secret Sharing

In any authentication scheme some global secret or common information must be present and any party that wants to authenticate itself to another party must have at least some information in common with the other party. Although it is theoretically possible to give the global secret to every device, in practice this is not recommended: if the global secret becomes known (by, for example, hacking one device), adversaries can take over the role of the Trusted Third Party (TTP) which distributed the global secret to trusted parties in the first place. This way, non-compliant devices enter the system and the security of the initial system is compromised making authentication futile. It will be impossible to detect the non-compliant devices because the total global secret is known.

A possible way to solve this is secret sharing: every trusted party gets a share of the global secret. This share is sufficient to be able to authenticate itself to an other party but a large number of shares is required to reconstruct the global secret (if possible at all). When one device is compromised, only a share of the global secret becomes known and measures can be taken to revoke this device.

The present invention uses a secret sharing protocol to allow the parties to determine a common secret. Usually the parties will then verify that the other knows the secret, see section “SECRET VERIFICATION” below. However, the parties might also go ahead without an explicit check. For instance, the secret could be used as an encryption key to encrypt some information sent to the other party. If the other party does not have the same secret, he cannot decrypt the information. This implicitly authorizes the other party.

FIG. 3 schematically shows a generalization of the system of FIG. 2, comprising a prover P, a verifier V and a trusted third party TTP. In accordance with the present invention, the verifier V wants to authenticate the prover P using information received from the trusted third party TTP. Preferably the authentication is mutual, so that the prover P also knows the verifier V is authentic.

The information necessary to authenticate the verifier V to the prover P is assumed to have been distributed from the TTP to the parties P and V beforehand. This can be done over a communication channel between the parties P and V and the TTP. This makes the protocol dynamic and allows easy updating of the information in case an adversary manages to obtain unauthorized access to a previously distributed secret.

The prover P and verifier V can be devices such as the carrier 120, equipped with a chip that provides the necessary functionality, and the audio playback device 105. In such a case, there will most likely not be a communications channel from the TTP to prover and verifier. Distribution of the secrets must then be done beforehand, for example in the factory where the carrier 120 or the device 105 is manufactured.

The prover P comprises a networking module 301, a cryptographic processor 302 and a storage medium 303. Using the networking module 301, the prover P can send data to and receive data from the verifier V. The networking module 301 could be connected to the network 110, or establish a direct connection (e.g. a wireless channel) with the verifier V.

The cryptographic processor 302 is arranged to execute the method according to the invention. Usually, this processor 302 is realized as a combination of hardware and software, but it could also be realized entirely in hardware or software, e.g. as a collection of software modules or objects.

The prover P can e.g. store the coefficients of the polynomials P and Q in the storage medium 303, but might also use it to hold some content that it wants to distribute to the verifier V after a successful authentication. The storage medium 303 may further be used to store the information received from the TTP. To enhance the security of the system, rather than storing the individual polynomials P and Q, the product Q_{q}(z)Pₚ(y) should be stored instead.

Similarly, the verifier V comprises a networking module 311, a cryptographic processor 312 and a storage 313 with functionality corresponding to that of the prover P. If the verifier V is embodied as a carrier 120 with Chip-In-Disc, then the storage 313 may correspond to the storage available to any (optical) disc but preferably is stored in ROM on the Chip-In-Disc.

Additionally, the prover P and the verifier V may be provided with a pseudo-random number generator 304, 314 (in hard-and/or software) that provides cryptographically strong pseudo-random numbers. These numbers are used in preferred embodiments of the method according to the invention. Several embodiments to authenticate the prover P to the verifier V will now be discussed with reference to FIGS. 4 and 5.

Generating a Common Secret Using Two Symmetrical Polynomials

FIG. 4 illustrates a secret sharing protocol based on two symmetrical polynomials each in two variables according to a preferred embodiment of the invention. Parts of the set-up and steps performed by the parties have already been explained above with reference to FIG. 1, and will not be repeated here.

The symmetric polynomial P is multiplied by a symmetrical polynomial Q(x,z), e.g. Q(x,z)=x·z. In addition to fixing the polynomial P in pᵢ, the polynomial Q is now fixed in qᵢ as well. The prover now receives from the TTP, instead of the polynomial P fixed in p₁, the product of the reduced polynomials:
Q(q₁,z)P(p₁,y)=Q_{q}_{₁}(z)Pₚ_{₁}(y)
as well as the values p₁ and q₁. Similarly, the verifier receives, instead of the polynomial P fixed in p₂, the product of the reduced polynomial
Q(q₂,z)P(p₂,y)=Q_{q}_{₂} (z)Pₚ_{₂}(y)
as well as the values p₂ and q₂ Preferably the prover and the verifier store the polynomials in the form of their coefficients:

$${g}_{1 j} = {q}_{1} {\sum }_{i = 0}^{n} {t}_{ij} {p}_{1}^{i} and {g}_{2 j} = {q}_{2} {\sum }_{i = 0}^{n} {t}_{ij} {p}_{2}^{i}$$

Preferably the values q₁ and q₂ are first multiplied by a random factor r by the TTP. This way, the values q₁ and q₂ are hidden to an adversary who may gain unauthorized access to the device embodying the prover and/or the verifier, preventing him from passing off as an authorized device.

From the above it follows that
Q_{q}_{₁}(rq₂)Pₚ_{₁}(p₂)=q₁rq₂P(p₁,p₂)=q₂rq₁P(p₂,p₁ )=Q_{q}_{₂}(rq₁)Pₚ_{₂}(p₁)
which demonstrates that the prover and the verifier are able to generate a common secret as the product of the polynomials P and Q using the elements pᵢ and qᵢ which they have and the elements pᵢ and qᵢ which they receive from the other party, even when the blinding factor r is used to hide the actual values of qᵢ.

If we now limit the number of values for pᵢ to n or less, the coefficients of the polynomials P and Q can not be retrieved. The number of values for qᵢ in the total system is not limited by the degree of the polynomial P, as is the case in the Blom system, but only by the number of possible elements qᵢ in the domain of Q. This makes it possible for a sufficient number of values qᵢ to supply every party with a unique share of the global secret.

Having received the product of the polynomials P and Q and the values pᵢ and qᵢ (or r·qᵢ), the parties P and V now attempt to generate a common secret, as illustrated in FIG. 4. Both parties exchange their values of pᵢ and qᵢ (or r·qᵢ), and compute their respective secrets S₁ and S₂. Preferably the parties P and V first generate respective random numbers r₁ and r₂. Then they compute r₁·qᵢ and r₂·q₂ respectively and exchange these products instead of the values q₁ and q₂ themselves. This has several advantages, amongst which is the fact that the random numbers r₁ and r₂ hide the values of q₁ and q₂, which makes it very difficult for an eavesdropper or a non-compliant device to learn something about q₁ and q₂. Additionally, it makes it possible for either of the parties (say, the prover P) to calculate its secret S1 as
S₁=Q(q₁, r₁·r₂·q₂)·P(p₁,p₂)

A further improvement of the system can be achieved by both parties applying a non-linear function to the calculated secret S1 and S2 before using it as a secret key. The non-linear function is preferably implemented as a one-way hash function but can also take the form of a polynomial.

Generating a Common Secret Using Limited Symmetrical Polynomials

FIG. 5 illustrates a variation on the protocol of FIG. 4 in which the polynomial P is symmetrical only in a limited number of points. The polynomial P is based on a symmetric matrix T and it can be shown that the polynomial P(x, y) is symmetrical for all values of x and y in the domain of P. However, if more than n different values pᵢ, are used, an adversary can theoretically reconstruct the matrix T. Therefore the polynomial P needs only be symmetric in m values p₁, . . . , pₘ with m≦n. In order to explain how to build polynomials which are symmetric only in a limited number of points, we first present some definitions.

The inner product of two n-dimensional vectors \vec{x}=(x₁, . . . , xₙ) and \vec{y}=(y₁, . . . ,yₙ) is given by

$$〈 {x}^{->} , {y}^{->} 〉 = {\sum }_{i = 1}^{n} {x}_{i} {y}_{i} .$$

The tensor product \vec{x}\mathring{×}\vec{y} of \vec{x} and \vec{y} is given by \vec{x}\mathring{×}\vec{y}=(x₁\vec{y}, . . . , xₙ\vec{y})

The Vandermonde vector \vec{p}^{V}^{ₙ} of length n+1 is associated with p given by \vec{p}^{V}^{ₙ}=(1, p, p², . . . , pⁿ). Unless stated otherwise, all Vandermonde vectors will have length n+1, and for ease of notation we will drop the subscript n. Given a subset {p₁, . . . , pₘ} of m≦n distinct values, we form the Vandermonde vectors \vec{p}ᵢ^{V}, . . . , \vec{p}ₘ^{V}. These m vectors are linearly independent. Thus, these vectors are the base vectors of a subspace A.

Next, we consider all possible tensor products \vec{p}ᵢ^{V}\mathring{×}\vec{p}ⱼ^{V} for i, j=1, . . . , m. It is known from tensor calculus that these m² tensor products form the basis of the tensor space A=A\mathring{×}A. For all vectors γ εA^{⊥} it then holds that
<\vec{γ},\vec{p}ᵢ^{V}\mathring{×}\vec{p}ⱼ^{V}>=0

Using the above definitions, the polynomial P(x,y) is rewritten as an inner product:
P(x,y)=<\vec{t},\vec{x}^{V}\mathring{×}\vec{y}^{V}>
where \vec{t} denotes the vector (t₀₀, . . . , t₀ₙ, t₁₀, . . . , tₙₙ). That is, it contains the entries of the matrix T. In its rewritten form, P is still symmetric.

We then choose m distinct elements p₁, . . . , pₘ. With these elements, we build Vandermonde vectors \vec{p}ᵢ^{V} and tensor products \vec{p}ᵢ^{V}\mathring{×}\vec{p}ⱼ^{V} from the Vandermonde vectors. We then choose a vector \vec{γ} from the perpendicular space A^{⊥} of the space A, as explained above. The rewritten form of the polynomial P can then be evaluated in points chosen from the preferred set {p₁, . . . , pₘ}. The vector \vec{γ} can be added to the vector \vec{t} and because \vec{γ} ε A^{⊥} we have
P(pᵢ,pⱼ)=<\vec{t}+\vec{γ},\vec{p}ᵢ^{V}\mathring{×}\vec{p}ⱼ^{V}>=<\vec{t},\vec{p}ᵢ^{V}\mathring{×}\vec{p}ⱼ^{V}>+<\vec{γ}, \vec{p}ᵢ^{V}\mathring{×}\vec{p}ⱼ^{V}>=<\vec{t},\vec{p}ᵢ^{V}\mathring{×}\vec{p}ⱼ^{V}>

In other words, if we derive from the vector \vec{γ}=(γ₁, . . . , γ₍ₙ₊₁₎_{²}) a matrix

$$Γ = ( \begin{matrix}{γ}_{1} & {γ}_{n + 2} & … & {γ}_{{n}^{2} + n + 1} \\ ⋮ & ⋮ & ⋰ & ⋮ \\ {γ}_{n + 1} & {γ}_{2 n + 2} & … & {γ}_{{( n + 1 )}^{2}}\end{matrix} )$$

and add this matrix Γ to the matrix T, we still have P(pᵢ, pⱼ)=P(pⱼ, pᵢ) for all pᵢ and pⱼ in the preferred set.

The above observations are used by the TTP to set up the system by performing the following operations:
1. The TTP chooses a random symmetric (n+1)×(n+1) matrix T and preferably an arbitrary value r.
2. The TTP chooses m distinct random elements p₁, . . . , pₘ with m≦n.
3. From the tensor products \vec{p}ᵢ^{V}\mathring{×}\vec{p}ⱼ^{V} the TTP calculates the space A.
4. From the m elements p₁, . . . , pₘ the TTP preferably chooses the first m′<m elements. This way, the system becomes renewable (explained below in section “RENEWABILITY”).

The TTP can then issue devices, that is, provide devices with a share of the global secret to allow these devices to (mutually) authenticate themselves with other devices with a share of the global secret. Such devices are often referred to as certified devices or authorized devices. Next to mutually authenticating other certified devices, a certified device can also detect an unauthorized device, usually because authentication with that device fails.

In order to issue a device, the TTP performs the following steps:
1. For a device i, the TTP randomly chooses \vec{γ}ᵢ ε A^{⊥} and pᵢ randomly from the set with m elements p₁, . . . , pₘ, preferably from the chosen subset with m′ elements.
2. The TTP generates a matrix Γᵢ from \vec{γ}ᵢ and forms the matrix T_{Γ}_{ᵢ}=T+Γᵢ
3. From T_{Γ}_{ᵢ} the TTP builds the bivariate polynomial P(x,y) and calculates the coefficients of the uni-variate polynomial P(pᵢ,y) which can be expressed as T_{Γ}_{ᵢ}\vec{p}ᵢ^{V}.
4. The TTP distributes the values pᵢ, r·qᵢ and the vector qᵢT_{Γ}_{ᵢ}\vec{p}ᵢ^{V} to the device i.

Having received their respective information, as indicated in FIG. 5, the parties P and V now exchange their values pᵢ and rᵢ·r·qᵢ and generate their respective secrets S₁ and S₂ as follows:
Sᵢ=Q_{q}_{ᵢ}(rᵢrⱼrqⱼ)Pₚ_{ᵢ}^{Γ}^{ᵢ}(pⱼ)=rᵢrⱼrqⱼ<qᵢT_{Γ}_{ᵢ}\vec{p}ᵢ^{V},\vec{p}ⱼ^{V}>

If S₁=S₂, then the parties have generated a common secret. The parties can implicitly conclude that the other party also knows the secret, or explicitly verify that the other party knows the same secret. This is discussed below at “SECRET VERIFICATION”.

Renewability

An important aspect of any authentication or common key generation scheme for a system like the system 100 is renewability. The TTP may wish to periodically replace the secrets installed in the devices 101-105 to foil adversaries who have managed to gain unauthorized access to the original secrets.

The embodiments illustrated in FIG. 5 can be used to introduce renewability into the system 100, by exploiting the properties explained in the previous sections. Initially the TTP issues devices using only the elements p₁, . . . , p_{m′} with m′<m≦n so that \vec{p}ᵢ^{V}\mathring{×}\vec{p}ⱼ^{V} with i,j ε {1, . . . , m′} span a space A′. However, the matrices T_{Γ}=T+Γ use Γ's derived from \vec{γ} ε A¹⁹⁵. If we denote the polynomial stored in a device i by T_{Γ}\vec{p}ᵢ^{V}, then that device contains the pair (T_{Γ}\vec{p}ᵢ^{V}, pᵢ).

Now we assume that somehow an adversary was able to retrieve the m′ elements pᵢ and also some device polynomial T_{Γ}\vec{p}ᵢ^{V}, for example by breaking open a device. The adversary can now generate a new vector \vec{γ}′ ε A′¹⁹⁵ and issue devices containing ((T_{Γ}+Γ′)\vec{p}ᵢ^{V}, pᵢ). These devices will work with all compliant devices containing one of the values p₁, . . . , p_{m′}: the adversary's device receives pⱼ ε {p₁, . . . , p_{m′}} from a compliant device and evaluates
P(pᵢ,pⱼ)=<\vec{t}+\vec{γ}ᵢ+\vec{γ}′,\vec{p}ᵢ^{V}\mathring{×}\vec{p}ⱼ^{V}>=\vec{t},\vec{p}ᵢ^{V}\mathring{×}\vec{p}ⱼ^{V}>
and the second party evaluates
P(pⱼ,pᵢ)=<\vec{t}+\vec{γ}ᵢ,\vec{p}ⱼ^{V}\mathring{×}\vec{p}ᵢ^{V}>=<\vec{t},\vec{p}ⱼ^{V}\mathring{×}\vec{p}ᵢ^{V}>=<\vec{t},\vec{p}ᵢ^{V}\mathring{×}\vec{p}ⱼ^{V}>
which shows that both evaluations are equal.

If the TTP notices that such devices are issued by an adversary, the TTP can start to issue devices using p_{m′+1}, . . . , p_{m″} with m′<m″≦m, such that tensor products of \vec{p}₁^{V} . . . \vec{p}_{m″}^{V} span a space A″. Note that A″^{⊥} ⊂ A′^{⊥}. Therefore these new devices will work with the adversary's device if the adversary had chosen \vec{γ}′ ε A″¹⁹⁵. If \vec{γ}′ is chosen randomly in A′¹⁹⁵ the probability that it is also in A″¹⁹⁵ is very small.

This provides the system with a certain amount of renewability: the new compliant devices issued by the TTP do not work with the adversary's devices with a very high probability. The maximum number of times the system can be renewed is m−1<n with n the degree of the polynomial P. This occurs when with each renewal one value of pᵢ ε {(p₁, . . . , pₘ} is added.

Secret Verification

After the parties have each independently generated the secret, the next step of the protocol is verifying that the other party knows the secret. If one of the parties can prove to the other party that he knows the secret, then this party is authenticated to the other party. Additionally, the other party may similarly authenticate himself to the first party to achieve mutual authentication.

Having verified that the prover knows the secret, the verifier can then use the secret S₁ to securely communicate some piece of information to the prover. For instance, an encryption key necessary to access encrypted content can be encrypted with S₁. The result can be transmitted to the prover, which in turn can recover the encryption key using S₂ (which is equal to S_{1,} as proven by the successful verification) and then decrypt and access the encrypted content.

There are several ways to verify that a party knows the secret generated as above. Two preferred embodiments are based on zero-knowledge protocols and conunitment-based protocols.

Zero-Knowledge Based Verification

First, verification based on zero-knowledge (ZK) protocols will be discussed. ZK-protocols are discussed in the Handbook of Applied Cryptography by A. Menezes, P. van Oorschot and S. van Stone, CRC Press 1996, pp. 405-416. In a preferred embodiment, the Guillou-Quisquater (GQ) zero-knowledge protocol is used, because it is efficient in terms of memory requirements and communication. The GQ protocol is known from U.S. Pat. No. 5,140,634 (attorney docket PHQ 87030) by the same assignee as the present application.

As explained above with reference to FIGS. 4 and 5, both parties P and V have evaluated their polynomials and thus obtained values S₁ and S₂, respectively. Either party must now prove to the other party in ZK that he knows Sᵢ. Since the GQ protocol is based on public key cryptography, we need a composite number m=pq which is the product of two primes p and q and a number e>I such that gcd(e, (p−1)(q−1))=1.

P will prove to V that he knows the e-th root of S₂^{e} mod m. The GQ protocol is illustrated in FIG. 6 where the values e and m are public. The protocol proceeds in accordance with the following steps:
1. V calculates v=S₂^{e},
2. P chooses a random number r ε {2, . . . , m−1} and sends r^{e} to V,
3. V chooses a random challenge c ε {1, . . . , e−1} and sends c to P
4. P replies with y=rS₁^{c},
5. V computes y^{e} and concludes that P knows the same secret as V if and only if y^{e}=(rS₁^{c})^{e} mod m=r^{e}v^{c} mod m=r^{e}(S₂^{e})^{C} mod m=(rS₂^{C})^{e} mod m, since this implies that S₁=S₂.

Because of the ZK properties of the protocol, V nor an eavesdropper will learn anything about the secret S₁ of P. On acceptance of P by V, the roles of P and V are interchanged and V will show to P that he knows the e-th root of S₁^{e} mod m. This way, P and V are mutually authenticated.

The set-up of the protocol differs slightly from what is found in the literature: normally, v=S₂^{e} is published and if P anticipates a challenge c*, he can send as a first message z^{e}v^{-c*} and still be accepted by V without knowledge of S₂. The probability of choosing the proper challenge is e⁻¹. In the current set-up it is not necessary to publish v =S₂ and this makes it impossible for P to calculate v^{-c*} from an anticipated challenge and this reduces the probability of unjust acceptance to m⁻¹. Therefore e can be chosen as low as 2, effectively transforming GQ into a Fiat-Shamir protocol but with an error probability m⁻¹ in one round. This means that the devices only have to perform modular exponentiations with small exponents in contrast with e.g. RSA.

To make it even more efficient, one might consider an implementation using a Montgomery representation (see P. L. Montgomery, Modular multiplication without trial division, Mathematics of Computation, Vol.44, no.170, April 1985, pp. 519-521).

Commitment-Based Verification

As an alternative for ZK protocols, a commitment-based protocol can be used to allow one party to verify that the other party knows the secret. An advantage of this approach is that symmetric key cryptography can be used, which can be implemented very efficiently.

In contrast to the previous situation, both parties P and V play the role of verifier and prover simultaneously which makes the protocol efficient in terms of communication. As before P computed S₁ and V computed S₂, respectively. The protocol (see FIG. 7) goes through the following steps:
1. V chooses a random number r with length matching the block length of the symmetric cipher.
2. V encrypts r using a symmetric cipher with S₂ as a key, and sends the encryption Eₛ₂(r) to P,
3. P decrypts the message using S₁. The result is r′=Dₛ_{₁}(E_{S}_{₂}(r)).
4. P chooses a random number R and sends a commitment on r′ to V. The commitment is obtained as a function commit(R,r′), discussed below.
5. V sends r to P and P checks if r′=r and stops further communication with V if this is not the case,
6. P sends r′ and R to V. V opens the commitment and checks if r′=r and stops further communication with P if the check is not satisfied.

The commit function should implement the binding and hiding properties of the commitment. Binding refers to P's ability to change the value r′ in the commitment. It must be difficult or impossible for P to find a value R′ such that commit(R, r′)=commit(R′, r). The hiding property refers to the ability of V to obtain information on r′ after receiving commit(R, r′). In practice, cryptographic hash functions or one-way functions are often used as commit functions.

In this set-up the symmetric cipher used to encrypt r can also be used as the commit function. The hiding property is trivially satisfied, because without knowledge of the randomly chosen R, V can not get information on r′, independent of the amount of computing power of V. Hence the commitment is unconditionally hiding. The binding property follows from the fact that for a symmetric cipher, E_{K}(X)=z is known to be a one-way function in K with x and z known: given E_{R}(r′) and r it is not known how to find a value R′ such that E_{R′}(r)=E_{R}(r′) in less than 2⁵⁵ operations. The commitment is thus computationally binding.

Next we consider the completeness and the soundness of the protocol. Completeness refers to the case that both parties execute the protocol correctly and S₁=S₂. It then follows by inspection and the symmetry properties of the symmetric cipher that when S₁=S₂, they will find r=r′.

Soundness refers to the situation of mutual acceptance when P does not know S₁ or V does not know S₂. To be unjustly accepted, P can send any value z as a commitment to V. After receiving r from V, P must find a value R′ such that commit(R′, r)=E_{R′}(r)=z. As explained above, E_{K}(X)=z is a one-way function in K for x and z given which makes finding R′ a difficult problem.

Similarly, if V does not know S₂ he can choose any value z to P who will reply with E_{R}(D_{S2}(z)). To be accepted, V has to obtain D_{S2}(z) which is very difficult because the commitment is unconditionally hiding due to the random value R. If S₁ happens to be a weak DES encryption key, V will be accepted if he chooses z such that D_{S1}(z)=z. For a weak key there are 2³² of such fixed points and the probability on unjust acceptance by P is 2³²/2⁶⁴=2⁻³².

### SOME ADVANTAGES OF THE INVENTION

The method according to the invention achieves a substantial saving in terms of required energy (power) in the devices in which it is executed, as well as a substantial saving in terms of processing time compared to authentication based on RSA.

In general, the power consumption depends on the architecture of the implementation. For example, varying the architecture, one can trade power consumption for clock speed. A second important factor is the technology which is used: modern technologies with small minimum feature sizes and low supply voltages will in general require less power than older technologies.

The table below gives an estimate of the required effort for the different parts of the protocols in terms of n (the degree of the polynomial), k (length in bits of a value), l (length in bits of the GQ modulus) and h (length in bits of the RSA modulus). The estimated effort is expressed in terms of single precision multiplications (sp-mults) i.e. the multiplication of two bits in the context of a multiplication of two k-bit numbers.

| Subprotocol | Required effort |
|---|---|
| Polynomial evaluation | k²(n + 3) sp-mults |
| GQ protocol | 20 l² sp-mults |
| Commit protocol | 100,000 gate transitions |
| RSA protocol | ¾ h³ sp-mults |

The table below shows estimates for the required energy for the subprotocols in Joule for a number of values for n, k, l and h and the amount of processing time when the invention is used in a Chip-In-Disc application with an available power of 0.5 mW.

| | n = 128 | n = 512 | n = 128 | n = 512 | n = 2048 | |
|---|---|---|---|---|---|---|
| | k = 64 | k = 64 | k = 128 | k = 128 | k = 64 | |
| | l = 512 | l = 512 | l = 1024 | l = 1024 | l = 1024 | |
| | h = 512 | h = 512 | h = 1024 | h = 1024 | h = 1024 | |
| Polynomial | 471 n | 1.86μ | 1.86μ | 7.35μ | 7.47μ | |
| GQ | 4.51μ | 4.51μ | 18.0μ | 18.0μ | 18.0μ | |
| Commit | 2 n | 2 n | 2 n | 2 n | 2 | n |
| Polynomial + | 4.98μ | 6.37μ | 19.9μ | 25.4μ | 25.5μ | |
| GQ | | | | | (52 | ms) |
| Polynomial + | 473 n | 1.87μ | 1.87μ | 7.36μ | 7.47μ | |
| Commit | | | | | (15 | ms) |
| RSA | 86.5μ | 86.5μ | 692μ | 692μ | 692μ | |
| | | | | | (1.4 | s) |

One should note that the values above are based on an estimate for the required energy per sp-mult. The real energy depends on the chosen architecture, layout, optimization goal in the design process (e.g. power or speed), etc. Nevertheless, the data in the above table give insight in the ratios of the energies required for the different protocols. It can be seen in the last column that, even for polynomials of degree 2048 and 64 bit values, the new protocols are a factor 30 to 100 more efficient than RSA.

In the special case of CID, which has a maximum of 0.5 mW power available, we derive that an RSA protocol would require approximately 1 second, while the protocols based on symmetric polynomials requires at most 52 ms.

It should be noted that the above-mentioned embodiments illustrate rather than limit the invention, and that those skilled in the art will be able to design many alternative embodiments without departing from the scope of the appended claims. While in the above the authentication method has been set out in the context of content protection and digital rights management, the invention is of course not restricted to this context.

The invention can be considered as a universal building block for authentication at interfaces between any pair of components and/or devices, especially when low power consumption is important. As such it can for instance also be applied in CD2, in set-top boxes, in wireless smartcards, wired or wireless networks, et cetera. The invention is also useful when a human verifier needs to authenticate a human prover using two respective interconnected devices.

It will be clear that where in the above the term “random number” or “arbitarily chosen number” is used, this includes numbers chosen using a pseudo-random number generator implemented in hardware and/or software, with or without seed values derived from truly random events. The security of the method depends for a great deal on the quality of the pseudo-random number generator.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of generating a common secret between a first party and a second party, in which the first party holds a value p₁ and a symmetrical polynomial P(x,y) fixed in the first argument by the value p₁, and the first party performs the steps of sending the value p₁to the second party, receiving a value p₂ from the second party and calculating the common secret S₁ by evaluating the polynomial P(p₁, y) in p₂, characterized in that the first party additionally holds a value q₁ and a symmetrical polynomial Q(x, z) fixed in the first argument by the value q₁, and further performs the steps of sending q₁ to the second party, receiving a value q₂ from the second party and calculating the secret S₁ as S₁=Q(q₁, q₂)·P(p₁, p₂).

2. The method of claim 1, in which the first party further performs the steps of obtaining a random number r₁, calculating r₁·q₁, sending r₁·q₁ to the second party, receiving r₂·q₂ from the second party and calculating the secret S₁ as S₁=Q(q₁, r₁·r₂·q₂)·P(p₁, p₂).

3. The method of claim 2, in which the first party holds the value q₁ multiplied by an arbitrarily chosen value r, and the product Q(q₁, z)P(p₁, y) instead of the individual polynomials P(p₁, y) and Q(q₁, z), and the first party performs the steps of calculating r₁·r·q₁, sending r₁·r·q₁ to the second party, receiving r₂·r·q₂ from the second party and calculating the secret S₁ as S₁=Q(q₁, r₁·r₂·r·q₂)·P(p₁, p₂).

4. The method of claim 1, in which the second party holds a value p₂ and a value q₂, the symmetrical polynomial P(x, y) fixed in the first argument by the value p₂, the symmetrical polynomial Q(x, z) fixed in the first argument by the value q₂, and the second party performs the steps of sending q₂ to the first party, receiving q₁ from the first party and calculating a secret S₂ as S₂=Q(q₂, q₁)·P(p₂, p₁), whereby the common secret has been generated if the secret S₂ equals the secret S_{1.}

5. The method of claim 1, in which a trusted third party performs the steps of choosing a symmetric (n+1)×(n+1) matrix T, constructing the polynomial P using entries from the matrix T as respective coefficients of the polynomial P, constructing the polynomial Q(x, y), choosing the value p₁, the value p₂, the value q₁ and the value q₂, sending the value p₁, the value q₁, the polynomial P(x, y) fixed in the first argument by the value p₁ and the polynomial Q(x, z) fixed in the first argument by the value q₁ to the first party, and sending the value p₂, the value q₂, the polynomial P(x, y) fixed in the first argument by the value p₂ and the polynomial Q(x, z) fixed in the first argument by the value q₂ to the second party

6. The method of claim 5, in which the trusted third party further arbitrarily chooses a value r, sends the value r·q₁ instead of the value q₁ and the product Q(q₁, z)P(p₁, y) instead of the individual polynomials P(p₁, y) and Q(q₁, z) to the first party and sends the value r·q₂ instead of the value q₂ and the product Q(q₂, z)P(p₂, y) instead of the individual polynomials P(p₂, y) and Q(q₂, z) to the second party.

7. The method of claim 5, in which the trusted third party further performs the steps of
choosing a set comprising m values p₁, including the values p₁ and p₂,
calculating a space A from the tensor products \vec{p}ᵢ^{V}\mathring{×}\vec{p}ⱼ^{V} of the Vandermonde vectors \vec{p}ᵢ^{V} built from the set of values pᵢ,
choosing a vector \vec{γ}₁ and a vector \vec{γ}₂ from the perpendicular space A¹⁹⁵ of the space A, constructing a matrix T_{Γ}_{₁}=T+Γ₁ from the vector \vec{γ}₁ and a matrix T_{Γ}_{₂}=T+Γ₂ from the vector \vec{γ}₂, constructing a polynomial P^{Γ}^{₁}(x,y) using entries from the matrix T_{Γ}_{₁},and sending the polynomial P^{Γ}^{₁}(x,y) fixed in the first argument by the value p₁ to the first party, and
constructing a polynomial P^{Γ}^{₂}(x,y) using entries from the matrix T_{Γ}_{₂} and sending the polynomial P^{Γ}^{₂}(x,y) fixed in the first argument by the value p₂ to the second party.

8. The method of claim 5, in which a number m′ of values p₁, and m′<m, are distributed to additional parties.

9. The method of claim 1, in which the first party and the second party use a non-linear function on the generated secret S1 and S2, respectively, before using it as a secret key in further communications.

10. The method of claim 9 in which a one-way hash function is applied to the generated secrets S1 and S2.

11. The method of claim 9 in which a non-linear function in the form of a polynomial is applied to the generated secrets S1 and S2.

12. The method of claim 1, further comprising the step of verifying that the second party knows the secret S₁.

13. The method of claim 12, in which the first party subsequently applies a zero-knowledge protocol to verify that the second party knows the secret S₁.

14. The method of claim 12, in which the first party subsequently applies a commitment-based protocol to verify that the second party knows the secret S₁.

15. The method of claim 14, in which the second party uses a symmetric cipher to encrypt a random challenge, and sends the encrypted random challenge to the first party and the first party subsequently uses the same symmetric cipher as a commit function to commit himself to a decryption of the encrypted random challenge.

16. A system (100) comprising a first party (P), a second party (V) and a trusted third party (TTP), arranged execute the method of claim 1.

17. A device (P) arranged to operate as the first party and/or as the second party in the system of claim 16.

18. The device of claim 17, comprising storage means (303) for storing the polynomial P and the polynomial Q in the form their respective coefficients.

19. A computer program product for causing one or more processors to execute the method of claim 1.
